(19) United States
(12) Patent Application Publication
(10) Pub. No.: US 2016/0082770 A1
(43) Pub. Date: Mar. 24, 2016

(54) Wheel Structure

(71) Applicant: Po-Chuan Tsai, Tainan City (TW)

(72) Inventor: Po-Chuan Tsai, Tainan City (TW)

(21) Appl. No.: 14/489,609

(22) Filed: Sep. 18, 2014

(51) Int. Cl. B60B 9/12

(52) U.S. Cl. CPC B60B 9/12; B60B 2900/523

(57) ABSTRACT

A wheel structure contains: a body and a rubber loop. The body is one piece formed and includes an arcuate face surrounding around an outer surface thereof, a peripheral groove defined around an outer rim of the arcuate face to fit with the rubber loop, a peripheral face defined around a peripheral side of the body, a first slot arranged around a left side of the peripheral face, and a second slot formed around a right side of the peripheral face, wherein the first slot and the second slot retain with the rubber loop.

### FIELD OF THE INVENTION

The present invention relates to a wheel structure which is one piece formed and contains a peripheral groove for fitting with a rubber loop securely.

### BACKGROUND OF THE INVENTION

Referring to FIGS. 1 and 2, a conventional wheel structure 1 contains a body 10, a cover 11, and a rubber loop 12. The body 10 has a plurality of notches 101 for retaining with the cover 11, and the cover 11 has a plurality of hooks 110 for retaining with the plurality of notches 101 of the body 10, such that the cover 11 is connected with the body 10 by ways of the plurality of hooks 110 and the plurality of notches 101, and then the body 10 is fitted with the rubber loop 12, thus assembling the wheel structure 1 completely.

However, the body 10 and the cover 11 are molded firstly so that the body 10 and the cover 11 are connected together, and then the rubber loop 12 is fitted with the body 10, thus producing the conventional wheel structure 1 complicatedly at a high cost.

The present invention has arisen to mitigate and/or obviate the afore-described disadvantages.

### SUMMARY OF THE INVENTION

The primary object of the present invention is to provide a wheel structure which contains a body one piece formed and contains a peripheral groove for fitting with a rubber loop securely.

Another primary object of the present invention is to provide a wheel structure which is produced easily at a low cost.

To obtain above objects, a wheel structure provided by the present invention contains: a body and a rubber loop.

The body is one piece formed and includes an arcuate face surrounding around an outer surface thereof, a peripheral groove defined around an outer rim of the arcuate face to fit with the rubber loop, a peripheral face defined around a peripheral side of the body, a first slot arranged around a left side of the peripheral face, and a second slot formed around a right side of the peripheral face, wherein the first slot and the second slot retain with the rubber loop.

### BRIEF DESCRIPTION OF THE DRAWINGS

FIG. 1 is a perspective view showing the assembly of a conventional wheel structure.

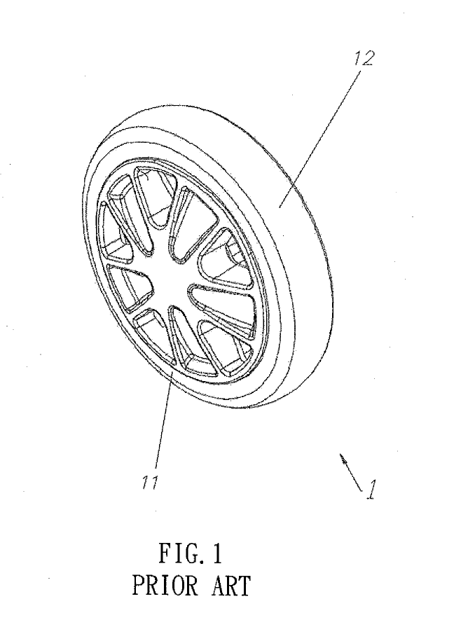

FIG. 2 is a perspective view showing the exploded components of the conventional wheel structure.

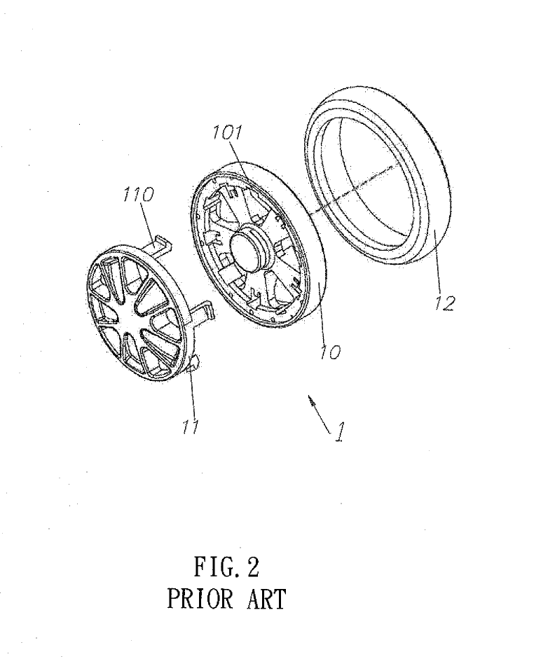

FIG. 3 is a perspective view showing the assembly of a wheel structure according to a preferred embodiment of the present invention.

FIG. 4 is a perspective view showing the exploded components of the wheel structure according to the preferred embodiment of the present invention.

FIG. 5 is a cross sectional view showing the assembly of the wheel structure according to the preferred embodiment of the present invention.

### DETAILED DESCRIPTION OF THE PREFERRED EMBODIMENTS

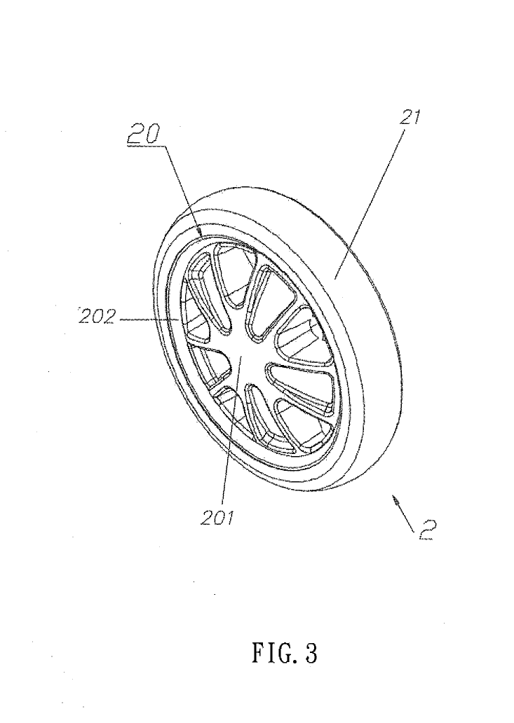

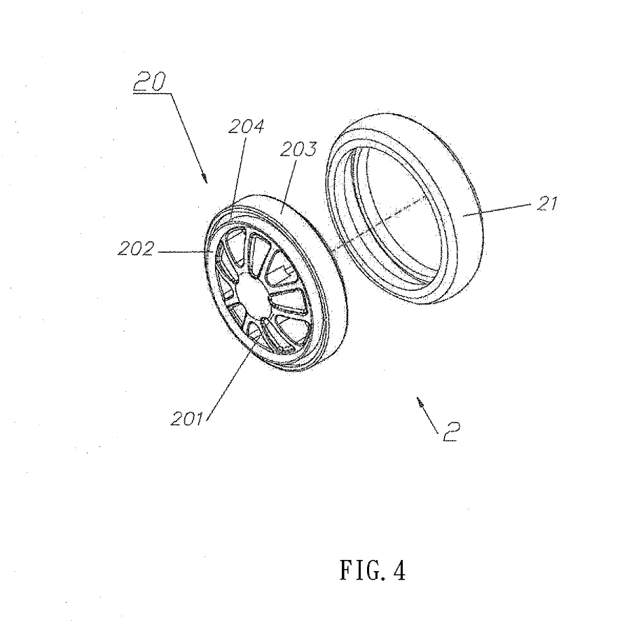

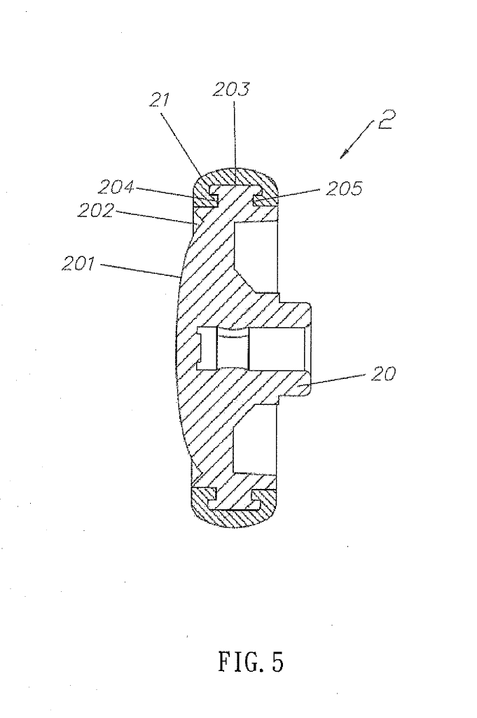

With reference to FIGS. 3 to 5, a wheel structure 2 according to a preferred embodiment of the present invention comprises: a body 20 and a rubber loop 21, wherein the body 20 is one piece formed and includes an arcuate face 201 surrounding around an outer surface thereof, a peripheral groove 202 defined around an outer rim of the arcuate face 201 to fit with the rubber loop 21, a peripheral face 203 defined around a peripheral side of the body 20, a first slot 204 arranged around a left side of the peripheral face 203, and a second slot 205 formed around aright side of the peripheral face 203, wherein the first slot 204 and the second slot 205 retain with the rubber loop 21.

Thereby, the rubber loop 21 is fitted on the peripheral face 203 of the body 20 and retains with the first slot 204 and the second slot 205, thus assembling the wheel structure 2 completely.

While we have shown and described various embodiments in accordance with the present invention, it is clear to those skilled in the art that further embodiments may be made without departing from the scope of the present invention.

What is claimed is:

1. A wheel structure comprising: a body and a rubber loop, wherein the body is one piece formed and includes an arcuate face surrounding around an outer surface thereof, a peripheral groove defined around an outer rim of the arcuate face to fit with the rubber loop, a peripheral face defined around a peripheral side of the body, a first slot arranged around a left side of the peripheral face, and a second slot formed around a right side of the peripheral face, wherein the first slot and the second slot retain with the rubber loop.
